(19) United States
(12) Patent Application Publication
(10) Pub. No.: US 2023/0151172 A1
(43) Pub. Date: May 18, 2023

(54) SALT-FREE FLLUOROPOLYMER MEMBRANE FOR ELECTROCHEMICAL DEVICES

(71) Applicants: Solvay SA, Brussels (BE); POLITECNICO DI TORINO, Turin (IT)

(72) Inventors: Daniele Battegazzore, Alessandria (IT); Alberto Frache, Alessandria (IT); Francesco Liberale, Pavia (IT); Julio A. Abusleme, Saronno (IT)

(73) Assignees: Solvay SA, Brussels (BE); POLITECNICO DI TORINO, Turin (IT)

(21) Appl. No.: 17/802,903

(22) PCT Filed: Feb. 11, 2021
(86) PCT No.: PCT/EP2021/053328

§ 371 Date: Aug. 26, 2022

(30) Foreign Application Priority Data
Feb. 27, 2020 (WO) 20159669.9

(51) Int. Cl. C08J 9/06; H01M 10/0565; C08J 9/00

(52) U.S. Cl. CPC C08J 9/06; H01M 10/0565; C08J 9/009; H01M 2300/0082; H01M 2300/0085; C08J 2327/16

(57) ABSTRACT

The invention pertains to a process for the manufacture of a polymer membrane based on a fluoropolymer hybrid organic/inorganic composite, to a polymer membrane obtained thereof and to use of said membranes obtained therefrom in various applications, especially in electrochemical and in photo-electrochemical applications.

### CROSS-REFERENCE TO RELATED APPLICATION

This application claims priority to European Patent Application 20159669.9 filed on 27 Feb. 2020, the whole content of this application being incorporated herein by reference for all purposes.

### TECHNICAL FIELD

The invention pertains to a process for the manufacture of a polymer membrane based on a fluoropolymer hybrid organic/inorganic composite, to a polymer membrane obtained thereof and to use of said membranes obtained therefrom in various applications, especially in electrochemical and in photo-electrochemical applications.

### BACKGROUND ART

Organic-inorganic polymer hybrids wherein inorganic solids on a nano or molecular level are dispersed in organic polymers have raised a great deal of scientific, technological and industrial interests because of their unique properties.

To elaborate organic-inorganic polymer hybrid composites, a sol-gel process using metal alkoxides is the most useful and important approach.

By properly controlling the reaction conditions of hydrolysis and polycondensation of metal alkoxydes, in particular of alkoxysilanes (e.g. tetramethoxysilane (TMOS) or tetraethoxysilane (TEOS)), in the presence of pre-formed organic polymers, it is possible to obtain hybrids with improved properties compared to the original compounds. The polymer can enhance the toughness and processability of otherwise brittle inorganic materials, wherein the inorganic network can enhance scratch resistance, mechanical properties and surface characteristics of said hybrids.

Hybrids made from sol-gel technique starting from fluoropolymers, in particular from vinylidene fluoride polymers are known in the art.

WO 2013/160240 discloses the manufacture of the fluoropolymer hybrid organic/inorganic composite in the presence of a liquid medium, to provide a self-standing fluoropolymer film stably comprising and retaining said liquid medium and having outstanding ionic conductivity. When the hybrid organic/inorganic composite is for use as polymer electrolyte separator in electrochemical and photo-electrochemical devices, it may be obtained by a process comprising hydrolysing and/or polycondensing a mixture comprising a fluoropolymer, a metal compound of formula X₄₋ₘAYₘ, an ionic liquid, a solvent for the fluoropolymer, and one electrolytic salt. The resulting liquid mixture is then processed into a film by a solvent casting procedure, and dried to obtain the film. Said film can be used as polymer membranes suitable for use in electrochemical devices such as secondary batteries.

WO 2015/169834 also describes a process to manufacture a fluoropolymer hybrid organic/inorganic composite endowed with outstanding crosslinking density properties, good ionic conductivity properties, and increased electrolyte retention within the polymer film. However, this process also requires the processing solvent to prepare a polymer solution, which hence necessitates an evaporation step of the processing solvent so as to obtain a film.

Unfortunately, preparing films by said solvent casting techniques requires the use of organic solvents like NMP, DMA, acetone and similar which are undesirable in an industrial production processes.

Accordingly, the quest for a process to produce a fluoropolymer hybrid organic/inorganic composite without using a processing solvent, exists in this field.

The polymer membranes based on a hybrid organic/inorganic composite manufactured by the methods of the prior art are typically gelled polymer electrolyte membranes containing a metal electrolytic salt, especially a Lithium salt.

Fluoropolymer electrolyte membranes characterized in that they are free from a metal salt, for instance Lithium salt, are also known in the art, for example from WO 2017/216184.

However, the preparation of membranes containing a metal salt without using undesirable processing solvents must be carried out in conditions of controlled humidity in a dry room, since otherwise the membrane may easily undergo hydrolysis.

The Applicant has now surprisingly found that it is possible to manufacture polymer membranes based on a hybrid organic/inorganic composite free from metal salts by a process that does not include casting with an undesirable solvent, with the advantage of avoiding the use and the subsequent recovery and disposal of said solvent.

The process according to the present invention has the further advantage that it can also be practiced in humid environment.

The polymer membranes based on a hybrid organic/inorganic composite prepared according to the process of the present invention are particularly suitable to be used in electrochemical devices, for example as separator coating or as polymer electrolyte membrane, once soaked with the electrolyte.

### SUMMARY OF INVENTION

It is thus an object of the present invention a process for manufacturing a polymer membrane based on a fluoropolymer hybrid organic/inorganic composite, said process comprising the following steps:
(i) providing a mixture that comprises:
   a metal compound of formula (I)

X₄₋ₘAYₘ (I)

wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)];
optionally, at least one acid catalyst; and
optionally, an aqueous liquid medium [medium (A)];
(ii) partially hydrolysing and/or polycondensing the metal compound of formula (I) by stirring the mixture provided in step (i) until the obtainment of a solid mixture (SM) that comprises a metal compound including one or more inorganic domains consisting of ≡A-O-A≡ bonds and one or more residual hydrolysable groups Y [metal compound (M)], wherein A and Y are as above defined; and
(iii) mixing the solid mixture (SM) provided in step (ii) with at least one fluoropolymer [polymer (F)] comprising recurring units derived from at least one fluorinated monomer [monomer (FM)] and at least one monomer comprising at least one hydroxyl group [monomer (OH)], so as to provide a solid composition (SC); and
(iv) processing the solid composition (SC) provided in step (iii) in the molten state, so that at least a fraction of hydroxyl groups of the monomer (OH) of polymer (F) reacts with at least a fraction of residual hydrolysable groups Y of said compound (M), so as to obtain a polymer membrane comprising a fluoropolymer hybrid organic/inorganic composite including the liquid medium (L).

In another object, the present invention provides a solid composition (SC) comprising the metal compound (M) and the at least one polymer (F), said composition being obtained according to step (iii) of the process as defined above.

In still another object, the present invention provides an alternative process for manufacturing a polymer membrane based on a fluoropolymer hybrid organic/inorganic composite, said process comprising the following steps:
(a) providing a mixture that comprises:
   a metal compound of formula (I)

X₄₋ₘAYₘ (I)

wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)];
optionally, at least one acid catalyst; and
optionally, an aqueous liquid medium [medium (A)]; and
at least one fluoropolymer [polymer (F)] comprising recurring units derived from at least one fluorinated monomer [monomer (FM)] and at least one monomer comprising at least one hydroxyl group [monomer (OH)];
   and
(b) partially hydrolysing and/or polycondensing the metal compound of formula (I) by stirring the mixture provided in step (a) until the obtainment of a solid composition (SCP) that comprises a metal compound including one or more inorganic domains consisting of ≡A-O-A≡ bonds and one or more residual hydrolysable groups Y [metal compound (M)], wherein A and Y are as above defined and at least one polymer (F) as above defined; and
(c) processing the solid composition (SCP) provided in step (b) in the molten state at least a fraction of hydroxyl groups of the monomer (OH) of polymer (F) reacts with at least a fraction of residual hydrolysable groups Y of said compound (M),
   so as to obtain a polymer membrane comprising a fluoropolymer hybrid organic/inorganic composite including the liquid medium (L).

In another object, the present invention provides a solid composition (SCP) comprising the metal compound (M) and the at least one polymer (F), said composition being obtained according to step (b) of the process as defined above.

A further object of the present invention is a polymer membrane that can be obtained by anyone of the processes as defined above.

It has been found that the polymer membrane of the present invention, despite being obtained by a process that does not include casting a solution of the polymer in a solvent, is endowed with good mechanical properties and homogeneity of the atomic distribution throughout its structure, thus avoiding the marked variations in surface composition and creating predictable and efficient ion transport pathways.

### DESCRIPTION OF EMBODIMENTS

By the term “solid mixture” or “solid composition” as used herein refers to any composition that is in a solid form. The term “solid mixture” or “solid composition” also encompasses compositions that are highly viscous mixtures in a semi-liquid form or semi-solid form, containing some liquid entrapped in the interstices of the solid matrix. For instance, a solid composition may be in the form of a powder, granule, paste, puree, wet mixture.

The metal compound of formula (I) can comprise one or more functional groups on any of groups X and Y, preferably on at least one group X.

In case compound of formula (I) comprises at least one functional group, it will be designated as functional compound; in case none of groups X and Y comprises a functional group, compound of formula (I) will be designated as non-functional compound (I).

Functional compounds can advantageously provide for a fluoropolymer hybrid organic/inorganic composite having functional groups, thus further modifying the chemistry and the properties of the hybrid composite over native polymer (F) and native inorganic phase.

As non-limitative examples of functional groups, mention can be made of epoxy group, carboxylic acid group (in its acid, ester, amide, anhydride, salt or halide form), sulphonic group (in its acid, ester, salt or halide form), hydroxyl group, phosphoric acid group (in its acid, ester, salt, or halide form), thiol group, amine group, quaternary ammonium group, ethylenically unsaturated group (like vinyl group), cyano group, urea group, organo-silane group, aromatic group.

To the aim of obtaining a polymer membrane based on fluoropolymer hybrid organic/inorganic composites having functional groups, it is generally preferred that any of groups X of metal compound of formula (I) or more functional groups and that m is an integer of 1 to 3, so that advantageously each A atom, after complete hydrolysis and/or polycondensation in either step (ii) or step (b) of the processes of the invention, will nevertheless be bound to a group comprising a functional group.

Preferably, X in metal compound of formula (I) is selected from C₁-C₁₈ hydrocarbon groups, optionally comprising one or more functional groups. More preferably, X in metal compound of formula (I) is a C₁-C₁₂ hydrocarbon group, optionally comprising one or more functional group.

With the aim of manufacturing a polymer membrane based on a fluoropolymer hybrid organic/inorganic composites which can exhibit functional behaviour in terms of hydrophilicity or ionic conductivity, functional group of metal compound of formula (I) will be preferably selected among carboxylic acid group (in its acid, anhydride, salt or halide form), sulfonic group (in its acid, salt or halide form), phosphoric acid group (in its acid, salt, or halide form), amine group, and quaternary ammonium group; most preferred will be carboxylic acid group (in its acid, anhydride, salt or halide form) and sulphonic group (in its acid, salt or halide form).

The selection of the hydrolysable group Y of the metal compound of formula (I) is not particularly limited, provided that it enables in appropriate conditions the formation of a —O-A≡ bond; said hydrolysable group can be notably a halogen (especially a chlorine atom), a hydrocarboxy group, a acyloxy group or a hydroxyl group.

Examples of functional metal compound of formula (I) are notably vinyltriethoxysilane, vinyltrimethoxysilane,

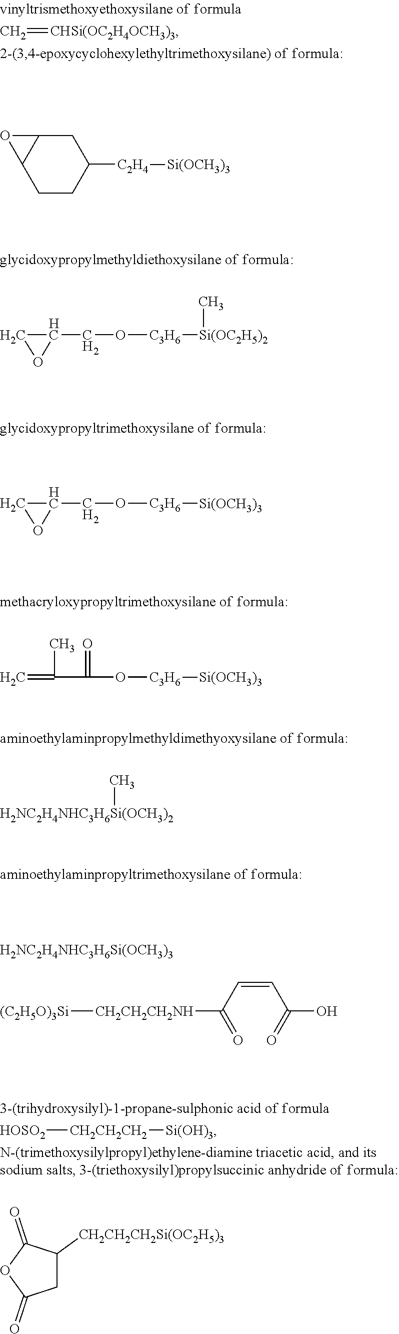

acetamidopropyltrimethoxysilane of formula H₃C—C(O)NH—CH₂CH₂CH₂—Si(OCH₃)₃, alkanolamine titanates of formula Ti(A)_{X}(OR)_{Y}, wherein A is an amine-substituted alkoxy group, e.g. OCH₂CH₂NH₂, R is an alkyl group, and x and y are integers such that x+y=4.

Examples of non-functional metal compound of formula (I) are notably triethoxysilane, trimethoxysilane, tetramethyltitanate, tetraethyltitanate, tetra-n-propyltitanate, tetraisopropyltitanate, tetra-n-butyltitanate, tetra-isobutyl titanate, tetra-tert-butyl titanate, tetra-n-pentyltitanate, tetra-n-hexyltitanate, tetraisooctyltitanate, tetra-n-lauryl titanate, tetraethylzirconate, tetra-n-propylzirconate, tetraisopropylzirconate, tetra-n-butyl zirconate, tetra-sec-butyl zirconate, tetra-tert-butyl zirconate, tetra-n-pentyl zirconate, tetra-tert-pentyl zirconate, tetra-tert-hexyl zirconate, tetra-n-heptyl zirconate, tetra-n-octyl zirconate, tetra-n-stearyl zirconate.

By the term “medium (L)” it is hereby intended to denote any liquid that is electrochemically stable and that may dissolve electrolyte salts.

Non-limitative examples of medium (L) suitable to be employed in the processes of the present invention typically include ionic liquids (IL), organic carbonates, and mixture thereof.

Non-limitative examples of suitable organic carbonates include, notably, ethylene carbonate, propylene carbonate, mixtures of ethylene carbonate and propylene carbonate, dimethyl carbonate, diethyl carbonate, ethyl-methyl carbonate, butylene carbonate, vinylene carbonate, fluoroethylene carbonate, fluoropropylene carbonate and mixtures thereof, preferably ethylene carbonate and propylene carbonate.

According to a second embodiment of the invention, the medium (L) comprises at least one organic carbonate and, optionally, at least one ionic liquid.

For the purpose of the present invention, the term “ionic liquid” is intended to denote a compound formed by the combination of a positively charged cation and a negatively charged anion in the liquid state at temperatures below 100° C. under atmospheric pressure.

The ionic liquid (IL) is typically selected from protic ionic liquid (ILₚ) and aprotic ionic liquids (ILₐ).

By the term “protic ionic liquid (ILₚ)”, it is hereby intended to denote an ionic liquid wherein the cation comprises one or more H⁺ hydrogen ions.

Non-limitative examples of cations comprising one or more H⁺ hydrogen ions include, notably, imidazolium, pyridinium, pyrrolidinium or piperidinium rings, wherein the nitrogen atom carrying the positive charge is bound to an H⁺ hydrogen ion.

By the term “aprotic ionic liquid (ILₐ)”, it is hereby intended to denote an ionic liquid wherein the cation is free of H⁺ hydrogen ions.

The liquid medium typically consists essentially of at least one ionic liquid (IL) and, optionally, at least one additive (A), wherein said ionic liquid (IL) is selected from protic ionic liquids (ILₚ), aprotic ionic liquids (ILₐ) and mixtures thereof.

The ionic liquid (IL) is typically selected from those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

Within the meaning of the present invention, by the term “alkyl group” it is meant saturated hydrocarbon chains or those carrying one or more double bonds and containing 1 to 30 carbon atoms, advantageously 1 to 18 carbon atoms and even more advantageously 1 to 8 carbon atoms. There can be mentioned by way of example the methyl, ethyl, propyl, iso-propyl, n-butyl, isobutyl, sec-butyl, t-butyl, pentyl, isopentyl, 2,2-dimethyl-propyl, hexyl, 2,3-dimethyl-2-butyl, heptyl, 2,2-dimethyl-3-pentyl, 2-methyl-2-hexyl, octyl, 4-methyl-3-heptyl, nonyl, decyl, undecyl and dodecyl groups.

In an advantageous embodiment of the present invention, the cation of the ionic liquid (IL) is selected from the followings:
a pyrrolidinium ring of formula (III) here below:

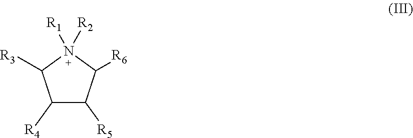

wherein R₁ and R₂ each represent independently an alkyl group with 1 to 8 carbon atoms and R₃, R₄, R₅, and R₆ each represent independently a hydrogen atom or an alkyl group with 1 to 30 carbon atoms, advantageously 1 to 18 carbon atoms, also more advantageously 1 to 8 carbon atoms, and
a piperidinium ring of formula (IV) here below:

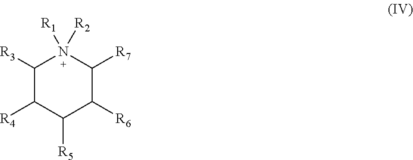

wherein R₁ and R₂ each represent independently of each other an alkyl group with 1 to 8 carbon atoms and R₃ to R₇ each represent independently of each other a hydrogen atom or an alkyl group with 1 to 30 carbon atoms, advantageously 1 to 18 carbon atoms, even more advantageously 1 to 8 carbon atoms.

In a particularly advantageous embodiment of the present invention, the cation of the ionic liquid (IL) is selected from the followings:

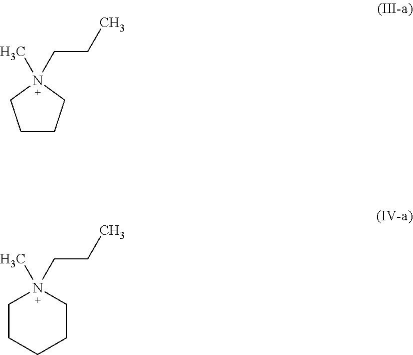

The ionic liquid (IL) is advantageously selected from those comprising as anion those chosen from halides anions, perfluorinated anions and borates.

The halide anions are in particular selected from the following anions: chloride, bromide, fluoride or iodide.

In a particularly advantageous embodiment of the present invention, the anion of the ionic liquid (IL) is selected from the followings:
bis(trifluoromethylsulphonyl)imide of formula (SO₂CF₃)₂N⁻,
hexafluorophosphate of formula PF₆⁻,
tetrafluoroborate of formula BF₄⁻, and
oxaloborate of formula:

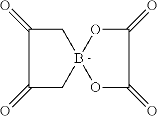

The medium (L) may further comprise one or more additives.

Should one or more additives be present in the liquid medium, non-limitative examples of suitable additives include, notably, those which are soluble in the liquid medium.

The selection of the acid catalyst is not particularly limited. The acid catalyst is typically selected from the group consisting of organic and inorganic acids.

The acid catalyst is preferably selected from the group consisting of organic acids; preferably the acid catalyst is citric acid or formic acid.

One skilled in the art will recognize that the amount of the acid catalyst to be used in the processes of the invention strongly depends on the nature of the catalyst itself.

The amount of the catalyst used in the processes of the invention may thus be advantageously of at least 0.1% by weight based on the total weight of the metal compound of formula (I).

In one embodiment of the present invention, the mixture provided in step (i) of the process of the invention includes at least one catalyst.

In another embodiment of the present invention, the mixture provided in step (i) of the process of the invention does not include any catalyst.

The amount of catalyst optionally used in the processes of the invention is advantageously of at most 40% by weight, preferably of at most 30% by weight based on the total weight of the metal compound of formula (I).

In a more preferred embodiment of the present invention, the mixture provided in step (i) of the process of the invention includes at least one acid catalyst, preferably citric acid.

In the processes of the invention, the metal compound of formula (I) may optionally be partially hydrolysed and/or polycondensed in the presence of an aqueous medium [medium (A)].

By the term “aqueous medium”, it is hereby intended to denote a liquid medium comprising water, which is in the liquid state at 20° C. under atmospheric pressure.

The aqueous medium (A) more preferably consists of water and one or more alcohols. The alcohol included in medium (A) is preferably ethanol.

In step (i) of the process of the invention, the mixture is conveniently prepared by adding into the reactor vessel, preferably in the order indicated here below, the following components as above defined:
the liquid medium (L),
the metal compound of formula (I),
optionally, the at least one acid catalyst, and,
optionally, the aqueous medium [medium (A)].

The amount of the metal compound of formula (I) used in the process of the invention is such that the mixture of step (i) comprises advantageously at least 20% by weight, preferably at least 25% by weight, more preferably at least 30% by weight of said metal compound of formula (I) based on the total weight of the metal compound of formula (I).

In one embodiment of the present invention, the mixture provided in step (i) of the process of the invention includes a medium (A) comprising, preferably consisting of, water and one or more alcohols.

The amount of medium (A) in the composition provided in step (i) is not particularly critical.

In a preferred embodiment, the amount of medium (A) is such to represent from 1 to 60%, preferably from 5 to 20% by weight of the composition provided in step (i) of the processes of the invention.

In one embodiment of the present invention, the mixture provided in step (i) of the process of the invention does not include any medium (A).

It is understood that in step (ii) of the process of the invention the hydrolysable groups Y of the metal compound of formula (I) as defined above are partially hydrolysed and/or polycondensed so as to yield a metal compound (M) comprising inorganic domains consisting of ≡A-O-A≡ bonds and one or more residual hydrolysable groups Y.

As this will be recognized by the skilled in the art, the hydrolysis and/or polycondensation reaction usually generates low molecular weight side products, which can be notably water or alcohol, as a function of the nature of the metal compound of formula (I) as defined above.

In step (ii) of the process of the invention the mixture provided in step (i) is stirred to a moderate to vigorous stirring, preferably in the range from 200 to 400 rpm, at a temperature and for a time sufficient to obtain a degree of hydrolysis and/or polycondensation of the metal compound of formula (I) which allows obtaining a solid mixture (SM) while keeping at least a residual fraction of the hydrolysable groups Y in metal compound (M).

The partial hydrolysis and/or polycondensation of the metal compound of formula (I) as defined above is suitably carried out at room temperature or upon heating at temperatures lower than 100° C. Temperatures between 20° C. and 90° C., preferably between 20° C. and 70° C. will be preferred.

In step (ii) the stirring time is not particularly limited, but is usually a time comprised in the range of from 10 minutes to 50 hours.

In a preferred embodiment according to the present invention, step (ii) is carried out by subjecting the mixture provided in step (i) to a vigorous stirring in the range from 200 to 400 rpm at a temperature of at least 30° C. for a time comprised in the range of from 24 to 48 hours.

In a preferred embodiment of the present invention, the vigorous stirring in step (ii) is carried out at a temperature ranging from 30° C. to 70° C.

Residual water and/or alcohol by-product formed during the hydrolysis and/or polycondensation reaction and/or residual aqueous liquid medium (A) may still be present in the solid mixture (SM) at the end of step (ii). An additional drying step may thus be included to remove those residual liquids.

In one embodiment of the present invention, step (ii) of the process as above defined thus includes a further step (ii_{bis}) of drying the solid mixture (SM) obtained in step (ii) at a temperature of at least 50° C.

The atmosphere in which step (ii_{bis}) is carried out is not particularly limited. For example, the step (ii_{bis}) may be carried out in an air atmosphere or a nitrogen atmosphere.

Drying step (ii_{bis}) may be suitably carried out in a ventilated oven, a fluidized bed, a rotary furnace, a fixed bed etc.

Drying step (ii_{bis}) is suitably carried out at a temperature ranging from 50° C. to 90° C. for a time comprised in the range of from 2 to 50 hours.

In a preferred embodiment according to the present invention, the process of the present invention comprises a further step (iiₜₑᵣ) of comminuting the solid mixture obtained in step (ii) or in step (ii_{bis}), so as to provide the solid mixture (SM) in the form of fine powder.

With reference to the solid mixture (SM), by the term “fine powder” it is hereby intended to denote a powder having average particle size diameter lower than 100 microns, preferably lower than 50 microns, more preferably lower than 20 microns.

Any milling method and apparatus known to the skilled persons can be used in this additional comminuting step (iiₜₑᵣ).

The solid mixture (SM) in the form of fine powder has advantages in terms of handling and feeding the equipment used in the following steps of the process.

Accordingly, a preferred embodiment of the present invention provides a process for manufacturing a polymer membrane based on a fluoropolymer hybrid organic/inorganic composite, said process comprising the following steps:

(i) providing a mixture that comprises:
a metal compound of formula (I)

X₄₋ₘAYₘ (I)

wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)];
optionally, at least one acid catalyst; and
optionally, an aqueous liquid medium [medium (A)];
   (ii) partially hydrolysing and/or polycondensing the metal compound of formula (I) by stirring the mixture provided in step (i) until the obtainment of a solid mixture (SM) that comprises a metal compound including one or more inorganic domains consisting of ≡A-O-A≡ bonds and one or more residual hydrolysable groups Y [metal compound (M)], wherein A and Y are as above defined; and
   (ii_{bis}) drying the solid mixture (SM) obtained in step (ii) at a temperature of at least 50° C.; and
   (iiₜₑᵣ) comminuting the solid mixture (SM) obtained in step (ii_{bis}), so as to provide the solid mixture (SM) in the form of fine powder.

In step (iii) of the process of the invention, the solid mixture (SM) obtained according to step (ii) is mixed with at least one fluoropolymer [polymer (F)] comprising recurring units derived from at least one fluorinated monomer [monomer (FM)] and at least one monomer comprising at least one hydroxyl group [monomer (OH)] to provide solid composition (SC).

The polymer (F) may be amorphous or semi-crystalline.

The term “amorphous” is hereby intended to denote a polymer (F) having a heat of fusion of less than 5 J/g, preferably of less than 3 J/g, more preferably of less than 2 J/g, as measured according to ASTM D-3418-08.

The term “semi-crystalline” is hereby intended to denote a polymer (F) having a heat of fusion of from 10 to 90 J/g, preferably of from 20 to 75 J/g, more preferably of from 25 to 65 J/g, as measured according to ASTM D3418-08.

The polymer (F) is preferably semi-crystalline.

Polymer (F) has notably an intrinsic viscosity, measured at 25° C. in N,N-dimethylformamide, comprised between 0.03 and 0.50 I/g, preferably comprised between 0.05 and 0.40 I/g, more preferably comprised between 0.08 and 0.30 I/g.

Non limitative examples of suitable fluorinated monomers (FM) include, notably, the followings:
C₃-C₈ perfluoroolefins, such as tetrafluoroethylene, and hexafluoropropene;
C₂-C₈ hydrogenated fluoroolefins, such as vinylidene fluoride, vinyl fluoride, 1,2-difluoroethylene and trifluoroethylene;
perfluoroalkylethylenes complying with formula CH₂═CH—R_{f0}, in which R_{f0} is a C₁-C₆ perfluoroalkyl;
chloro- and/or bromo- and/or iodo-C₂-C₆ fluoroolefins, like chlorotrifluoroethylene;
(per)fluoroalkylvinylethers complying with formula CF₂═CFOR_{f1} in which R_{f1} is a C₁-C₆ fluoro- or perfluoroalkyl, e.g. CF₃, C₂F₅, C₃F₇;
CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups, like perfluoro-2-propoxy-propyl;
(per)fluoroalkylvinylethers complying with formula CF₂═CFOCF₂OR_{f2} in which R_{f2} is a C₁-C₆ fluoro- or perfluoroalkyl, e.g. CF₃, C₂F₅, C₃F₇ or a C₁-C₆ (per)fluorooxyalkyl having one or more ether groups, like —C₂F₅—O—CF₃;
functional (per)fluoro-oxyalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;
fluorodioxoles, especially perfluorodioxoles.

The polymer (F) comprises preferably more than 25% by moles, preferably more than 30% by moles, more preferably more than 40% by moles of recurring units derived from at least one fluorinated monomer (FM).

Preferred polymers (F) are those wherein the fluorinated monomer (FM) is chosen from the group consisting of vinylidene fluoride (VDF), tetrafluoroethylene (TFE), hexafluoropropene (HFP) and chlorotrifluoroethylene (CTFE).

The monomer (OH) may be selected from the group consisting of fluorinated monomers comprising at least one hydroxyl group and hydrogenated monomers comprising at least one hydroxyl group.

By the term “fluorinated monomer”, it is hereby intended to denote an ethylenically unsaturated monomer comprising at least one fluorine atom.

By the term “hydrogenated monomer”, it is hereby intended to denote an ethylenically unsaturated monomer comprising at least one hydrogen atom and free from fluorine atoms.

The monomer (OH) is typically selected from the group consisting of hydrogenated monomers comprising at least one hydroxyl group.

The monomer (OH) is preferably selected from the group consisting of (meth)acrylic monomers of formula (V) or vinylether monomers of formula (VI)

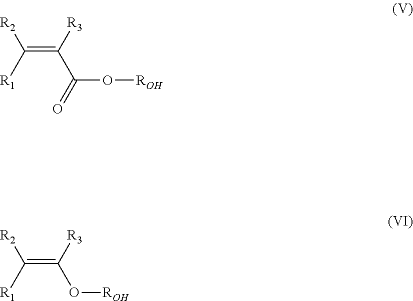

wherein each of R₁, R₂ and R₃, equal to or different from each other, is independently a hydrogen atom or a C₁-C₃ hydrocarbon group, and R_{OH} is a C₁-C₅ hydrocarbon moiety comprising at least one hydroxyl group.

The monomer (OH) even more preferably complies with formula (V-A):

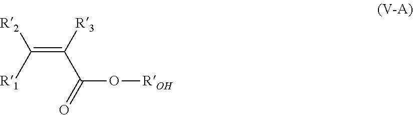

wherein R′₁, R′₂ and R′₃ are hydrogen atoms and R′_{OH} is a C₁-C₅ hydrocarbon moiety comprising at least one hydroxyl group.

Non-limitative examples of suitable monomers (OH) include, notably, hydroxyethyl (meth)acrylate, hydroxypropyl(meth)acrylate; hydroxyethylhexyl(meth)acrylates.

The monomer (OH) is more preferably selected among the followings:

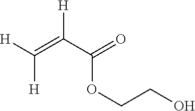

2-hydroxypropyl acrylate (HPA) of either of formulae:

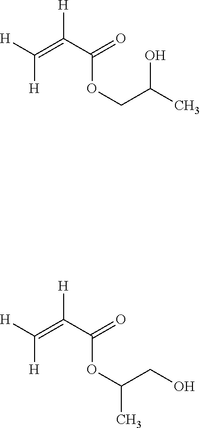

and mixtures thereof.

The monomer (OH) is even more preferably HPA and/or HEA.

The term “at least one fluorinated monomer [monomer (FM)]” is understood to mean that the polymer (F) may comprise recurring units derived from one or more than one monomers (FM) as defined above. In the rest of the text, the expression “monomer (FM)” is understood, for the purposes of the present invention, both in the plural and the singular, that is to say that they denote both one and more than one monomers (FM) as defined above.

The term “at least one monomer comprising at least one hydroxyl group [monomer (OH)]” is understood to mean that the polymer (F) may comprise recurring units derived from one or more than one monomers (OH) as defined above. In the rest of the text, the expression “monomer (OH)” is understood, for the purposes of the present invention, both in the plural and the singular, that is to say that they denote both one and more than one monomers (OH) as defined above.

The polymer (F) comprises preferably at least 0.01% by moles, more preferably at least 0.05% by moles, even more preferably at least 0.1% by moles of recurring units derived from at least one monomer (OH) as defined above.

The polymer (F) comprises preferably at most 20% by moles, more preferably at most 15% by moles, even more preferably at most 10% by moles, most preferably at most 3% by moles of recurring units derived from at least one monomer (OH) as defined above.

Determination of average mole percentage of monomer (OH) recurring units in polymer (F) can be performed by any suitable method. Mention can be notably made of NMR methods.

Polymer (F) preferably comprises:

(a) at least 60% by moles, preferably at least 75% by moles, more preferably at least 85% by moles of vinylidene fluoride (VDF);
(b) optionally, from 0.1% to 15% by moles, preferably from 0.1% to 12% by moles, more preferably from 0.1% to 10% by moles of a fluorinated comonomer selected from chlorotrifluoroethylene (CTFE), hexafluoropropene (HFP), tetrafluoroethylene (TFE), trifluoroethylene (TrFE), perfluoromethylvinylether (PMVE) and mixtures therefrom; and
(c) from 0.05% to 10% by moles, preferably from 0.1% to 7.5% by moles, more preferably from 0.2% to 3.0% by moles of monomer (OH) having formula (V) as defined above.

Solid composition (SC) provided in step (iii) of the process of the invention preferably comprises polymer (F) in an amount comprised between 5% and 99.99% by weight, preferably between 10% and 70% by weight based on the total weight of solid composition (SC).

Any equipment suitable for obtaining the mixing of powders can be used in step (iii) of the process of the invention.

Solid composition (SC) can be suitably stocked and stored for future uses, with advantages in terms of process optimization.

In step (iv) of the process of the invention, solid composition (SC) is processed at temperatures typically between 50° C. and 300° C., preferably between 80° C. and 200° C. typically using melt-processing techniques, preferably by extrusion techniques.

In a preferred embodiment according to the invention, a solid composition (SC) prepared by using the liquid medium (L) composed of organic carbonates is processed in step (iv) by extrusion at temperatures generally comprised between 80° C. and 120° C.

The reaction in step (iv) of the process of the invention usually takes place in the twin screw extruder. Surplus reaction heat is commonly dissipated through the barrel wall.

It is understood that, in this step (iv) of the process of the invention, at least a fraction of the hydroxyl groups of the polymer (F) and at least a fraction of the residual hydrolysable groups Y of the metal compound (M)] are reacted so as to yield a fluoropolymer hybrid composite consisting of organic domains consisting of chains of polymer (F) and inorganic domains consisting of ≡A-O-A≡ bonds, thus providing a polymer membrane comprising a fluoropolymer hybrid organic/inorganic composite already including the liquid medium (L).

The fluoropolymer hybrid organic/inorganic composite comprised in the polymer membrane obtained from the process of the invention advantageously comprises from 0.01% to 60% by weight, preferably from 0.1% to 40% by weight of inorganic domains consisting of ≡A-O-A≡ bonds.

In step (iv) of the process of the present invention a the solid composition (SC) comprising a fluoropolymer hybrid organic/inorganic composite is processed in the form of a film directly in the extruder so as to provide a polymer membrane.

In a second object, the present invention provides a solid composition (SC) comprising the metal compound (M) and the at least one polymer (F), said composition being obtained according to step (iii) of the process as defined above.

In another object, the present invention provides an alternative process for the manufacturing of the polymer membrane based on a fluoropolymer hybrid organic/inorganic composite as above defined.

In step (a) of the process of the invention, a mixture is conveniently prepared by adding into the reactor vessel, preferably in the order indicated here below, the following components as above defined:
the liquid medium (L),
the metal compound of formula (I),
the at least one polymer (F),
optionally, the at least one acid catalyst, and,
optionally, the aqueous medium [medium (A)].

The amount of the metal compound of formula (I) used in the process of the invention is such that the mixture of step (a) comprises advantageously at least 20% by weight, preferably at least 25% by weight, more preferably at least 30% by weight of said metal compound of formula (I) based on the total weight of the metal compound of formula (I) and the liquid medium (L) in said mixture.

In one preferred embodiment of the present invention, the mixture provided in step (a) of the process of the invention includes at least one acid catalyst. The acid catalyst is preferably selected from formic acid or citric acid.

In one embodiment of the present invention, the mixture provided in step (a) of the process of the invention includes a medium (A) comprising, preferably consisting of, water and one or more alcohols.

The amount of medium (A) in the composition provided in step (a) is not particularly critical.

In a preferred embodiment, the amount of medium (A) is such to represent from 1 to 60%, preferably from 5 to 20% by weight of the composition provided in step (a) of the processes of the invention.

It is understood that in step (b) of the process of the invention the hydrolysable groups Y of the metal compound of formula (I) as defined above are partially hydrolysed and/or polycondensed so as to yield a metal compound (M) comprising inorganic domains consisting of ≡A-O-A≡ bonds and one or more residual hydrolysable groups Y.

In step (b) of the process of the invention the mixture provided in step (a) is stirred to a moderate to vigorous stirring, preferably in the range from 200 to 400 rpm, at a temperature and for a time sufficient to obtain a degree of hydrolysis and/or polycondensation of the metal compound of formula (I) which allows obtaining a solid composition (SCP) while keeping at least a residual fraction of the hydrolysable groups Y in metal compound (M).

The partial hydrolysis and/or polycondensation of the metal compound of formula (I) as defined above is suitably carried out at room temperature or upon heating at temperatures lower than 100° C. Temperatures between 20° C. and 90° C., preferably between 20° C. and 70° C. will be preferred.

In step (b) the stirring time is not particularly limited, but is usually a time comprised in the range of from 10 minutes to 50 hours.

In a preferred embodiment according to the present invention, step (b) is advantageously carried out by subjecting the mixture provided in step (a) to a vigorous stirring in the range from 200 to 400 rpm at a temperature of at least 30° C. for a time comprised in the range of from 24 to 48 hours.

In a preferred embodiment of the present invention, the vigorous stirring in step (b) is carried out at a temperature ranging from 30° C. to 70° C.

Residual water and/or alcohol by-product formed during the hydrolysis and/or polycondensation reaction and/or residual aqueous liquid medium (A) may still be present in the solid composition (SCP) at the end of step (b). An additional drying step may thus be included to remove those residual liquids.

In one embodiment of the present invention, step (b) of the process as above defined thus includes a further step (b_{bis}) of drying the solid composition obtained in step (b) at a temperature of at least 50° C.

The atmosphere in which step (b_{bis}) is carried out is not particularly limited. For example, the step (b_{bis}) may be carried out in an air atmosphere or a nitrogen atmosphere.

Drying step (b_{bis}) may be suitably carried out in a ventilated oven, a fluidized bed, a rotary furnace, a fixed bed, or in any dryers (hot air, desiccant, compressed air, vacuum) available in the market, etc.

Drying step (b_{bis}) is suitably carried out at a temperature ranging from 50° C. to 90° C. for a time comprised in the range of from 2 to 50 hours.

One skilled in the art will recognize that the total time in step (b) for obtaining a solid composition (SCP) starting from the mixture provided in step (a) strongly depends on the amount of liquid present in said mixture.

In a preferred embodiment according to the present invention, the process of the present invention comprises a further step (bₜₑᵣ) of comminuting the solid mixture obtained in step (b) or in step (b_{bis}), so as to provide the solid mixture in the form of fine powder.

With reference to solid composition (SCP), by the term “fine powder” it is hereby intended to denote a powder having average particle size diameter lower than 100 microns, preferably lower than 50 microns, more preferably lower than 20 microns.

Any milling method and apparatus known to the skilled persons can be used in this additional comminuting step (bₜₑᵣ).

According to said preferred embodiment, the present invention provides a process for manufacturing a polymer membrane based on a fluoropolymer hybrid organic/inorganic composite, said process comprising the following steps:

(a) providing a mixture comprising:
a metal compound of formula (I)

X₄₋ₘAYₘ (I)

wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)] formed of organic carbonates;
optionally, at least one acid catalyst;
optionally, an aqueous liquid medium [medium (A)]; and
at least one fluoropolymer [polymer (F)] comprising recurring units derived from at least one fluorinated monomer [monomer (FM)] and at least one monomer comprising at least one hydroxyl group [monomer (OH)];
   (b) partially hydrolysing and/or polycondensing the metal compound of formula (I) by stirring the mixture provided in step (a) until the obtainment of a solid composition (SCP) that comprises a metal compound including one or more inorganic domains consisting of ≡A-O-A≡ bonds and one or more residual hydrolysable groups Y [metal compound (M)], wherein A and Y are as above defined; and
   (b_{bis}) drying the solid composition obtained in step (b) at a temperature of at least 50° C.; and
   (bₜₑᵣ) comminuting the solid mixture obtained in step (b_{bis}), so as to provide the solid composition (SCP) in the form of fine powder.

Solid composition (SCP) preferably comprises polymer (F) in an amount comprised between 5% and 99.99% by weight, preferably between 10% and 50% by weight based on the total weight of solid composition (SCP).

Solid composition (SCP) can be suitably stocked and stored for future uses, with advantages in terms of process optimization.

The Applicants have surprisingly found that solid composition (SCP) is particularly easy-flowing, which makes it easier to be stored and particularly advantageous in terms of handling, which makes the feeding of the equipment wherein the next step in molten state takes place particularly easy and efficient.

In said step (c), the polymer (F) and the metal compound (M) are typically processed using melt-processing techniques.

Preferred melt-processing technique used in step (c) of the process is extrusion at temperatures generally comprised between 50° C. and 300° C.

The reaction in step (c) of the process of the invention usually takes place in the twin screw extruder. Surplus reaction heat is commonly dissipated through the barrel wall.

It is understood that, in this step (c) of the process of the invention, at least a fraction of the hydroxyl groups of the polymer (F) and at least a fraction of the residual hydrolysable groups Y of the metal compound (M)] are reacted so as to yield a fluoropolymer hybrid composite consisting of organic domains consisting of chains of polymer (F) and inorganic domains consisting of ≡A-O-A≡ bonds, thus providing a polymer membrane comprising a fluoropolymer hybrid organic/inorganic composite already including the organic carbonates.

The fluoropolymer hybrid organic/inorganic composite comprised in the polymer film or membrane obtained from the process of the invention advantageously comprises from 0.01% to 60% by weight, preferably from 0.1% to 40% by weight of inorganic domains consisting of ≡A-O-A≡ bonds.

In step (c) of the process of the present invention a solid composition (SCP) comprising a fluoropolymer hybrid organic/inorganic composite is processed in the form of a film directly in the extruder so as to provide a polymer membrane.

The amount of the metal compound of formula (I) used in the process of the invention is such that the solid composition (SCP) provided in step (b) comprises advantageously at least 0.1% by weight, preferably at least 1% by weight, more preferably at least 5% by weight of compound (M) based on the total weight of the polymer (F) and the compound (M) in said solid composition (SCP).

The amount of the metal compound of formula (I) used in the process of the invention is such that the solid composition (SCP) provided in step (b) comprises advantageously at most 95% by weight, preferably at most 75% by weight, more preferably at most 55% by weight of said compound (M) based on the total weight of the polymer (F) and the compound (M) in said solid composition (SCP).

Solid composition (SCP) provided in step (b) of the process of the invention preferably comprises polymer (F) in an amount comprised between 5% and 99.99% by weight, preferably between 10% and 50% by weight based on the total weight of solid composition (SCP).

In another object, the present invention provides a solid composition (SCP) comprising a metal compound [compound (M)] comprising one or more inorganic domains consisting of ≡A-O-A≡ bonds and one or more residual hydrolysable groups Y, wherein A is a metal selected from the group consisting of Si, Ti and Zr, Y is a hydrolysable group selected from the group consisting of an alkoxy group, an acyloxy group, and at least one fluoropolymer [polymer (F)] comprising recurring units derived from at least one fluorinated monomer [monomer (FM)] and at least one monomer comprising at least one hydroxyl group [monomer (OH)],

said solid composition (SCP) being obtained according to step (b) of the process as defined above.

For the purpose of the present invention, the term “membrane” is intended to denote a discrete, generally thin and dense, interface that moderates permeation of chemical species in contact with it. This interface is in general homogeneous completely uniform in structure.

The polymer membranes of the present invention typically have a thickness comprised between 5 μm and 500 μm, preferably between 10 μm and 250 μm, more preferably between 15 μm and 50 μm.

A further object of the present invention is a polymer membrane which can be obtained by any of the processes as defined above.

The polymer membrane of the present invention, when the liquid medium (L) is formed by ionic liquids, can be conveniently subjected to a thermal post-treatment in order to further improve its mechanical properties. Thermal post-treatment can be suitably carried out by submitting the membrane to a temperature in the range comprised between 100 and 150° C. for a time ranging from 20 minutes to 3 hours.

In a further instance, the present invention pertains to an electrochemical device, preferably a secondary battery, comprising at least one polymer membrane of the invention placed between a positive electrode (pE) and a negative electrode (nE), wherein at least one of the positive electrode (pE) and the negative electrode (nE) comprises:
a current collector, and
adhered to said current collector, at least one fluoropolymer layer comprising, preferably consisting of:
at least one fluoropolymer (P),
at least one electro-active compound [compound (EA)],
a liquid medium [medium (L)],
at least one metal salt [salt (M)],
optionally, at least one conductive compound [compound (C)], and
optionally, one or more additives.

In a further instance, the present invention pertains to an electrochemical device, preferably a secondary battery, comprising at least one polymer membrane of the invention between a positive electrode (pE) and a negative electrode (nE),

wherein both the positive electrode (pE) and the negative electrode (nE) comprises:
a current collector, and
adhered to said current collector, at least one fluoropolymer layer comprising, preferably consisting of:
at least one fluoropolymer (P),
at least one electro-active compound [compound (EA)],
a liquid medium [medium (L)],
at least one metal salt [salt (M)],
optionally, at least one conductive compound [compound (C)], and
optionally, one or more additives.

In a further instance, the present invention pertains to an electrochemical device, preferably a secondary battery, comprising at least one polymer membrane of the invention between a positive electrode (pE) and a negative electrode (nE), wherein the negative electrode (nE) comprises:
a current collector, and
adhered to said current collector, at least one fluoropolymer layer comprising, preferably consisting of:
at least one fluoropolymer (P),
at least one electro-active compound [compound (EA)],
a liquid medium [medium (L)],
at least one metal salt [salt (M)],
optionally, at least one conductive compound [compound (C)], and
optionally, one or more additives.

The medium (L) of any of the positive electrode (pE) and the negative electrode (nE) of the electrochemical device may be equal to or different from the medium (L) of the polymer membrane of the invention.

By the term “metal salt (S)”, it is hereby intended to denote a metal salt comprising electrically conductive ions.

A variety of metal salts may be employed as metal salts (S). Metal salts which are stable and soluble in the chosen liquid medium (L) are generally used.

Non-limitative examples of suitable metal salts (S) include, notably, MeI, Me(PF₆)ₙ, Me(BF₄)ₙ, Me(ClO₄)ₙ, Me(bis(oxalato)borate)ₙ(“Me(BOB)ₙ”), MeCF₃SO₃, Me[N(CF₃SO₂)₂]ₙ, Me[N(C₂F₅SO₂)₂]ₙ, Me[N(CF₃SO₂)(R_{F}SO₂)] with R_{F} being C₂F₅, C₄F₉, CF₃OCF₂CF₂, Me(AsF₆)ₙ, Me[C(CF₃SO₂)₃]ₙ, Me₂Sₙ, wherein Me is a metal, preferably a transition metal, an alkaline metal or an alkaline-earth metal, more preferably Me being Li, Na, K, Cs, and n is the valence of said metal, typically n being 1 or 2.

Preferred metal salts (S) are selected from the followings: LiI, LiPF₆, LiBF₄, LiClO₄, lithium bis(oxalato)borate (“LiBOB”), LiCF₃SO₃, LiN(CF₃SO₂)₂ (“LiTFSI”), LiN(C₂F₅SO₂)₂, M[N(CF₃SO₂)(R_{F}SO₂)]ₙ with R_{F} being C₂F₅, C₄F₉, CF₃OCF₂CF₂, LiAsF₆, LiC(CF₃SO₂)₃, Li₂Sₙ and combinations thereof.

The fluoropolymer (P) is a semi-crystalline fluoropolymer comprising:
recurring units derived from vinylidene fluoride (VDF),
recurring units derived from at least one hydrophilic (meth)acrylic monomer (MA) of formula (VII):

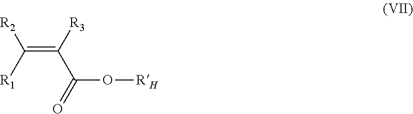

wherein:
R₁, R₂ and R₃, equal to or different from each other, are independently selected from a hydrogen atom and a C₁-C₃ hydrocarbon group, and
R′_{H} is a hydrogen atom or a C₁-C₅ hydrocarbon moiety comprising at least one carboxyl group,
   said fluoropolymer (P) having an intrinsic viscosity measured in dimethylformamide at 25° C. higher than 0.20 I/g.

Fluoropolymer (P) may also include recurring units derived from at least one fluorinated monomer (FM) as above defined, different from VDF, in an amount of from 0.5% to 5.0% by moles, preferably from 1.5 to 4.5% by moles, more preferably from 1.5% to 3.0% by moles, even more preferably from 2.0 to 3.0% by moles with respect to the total amount of moles of recurring units in said polymer (P).

The fluorinated monomer (FM) in fluoropolymer (P) is preferably hexafluoropropene (HFP).

In a preferred embodiment of the present invention, the fluoropolymer (P) is a fluoropolymer comprising recurring units derived from VDF, recurring units derived from a compound of formula (VII) wherein R′_{H} is a hydrogen and recurring units derived from HFP.

The polymer membrane of the present invention is advantageously free from one or more metal electrolytic salts.

The Applicant thinks, without this limiting the scope of the invention, that one or more metal salts (S) and, optionally, one or more additives advantageously migrate from any of the positive electrode (pE) and the negative electrode (nE) towards the membrane of the invention thereby ensuring good electrochemical performances of the electrochemical device thereby provided.

The polymer membrane of the invention can be advantageously used as polymer separator in electrochemical and photo-electrochemical devices.

The polymer membrane of the invention can be advantageously used also as separator coating in electrochemical and photo-electrochemical devices.

Non-limitative examples of suitable electrochemical devices include, notably, secondary batteries, especially Lithium-ion batteries and Lithium-Sulfur batteries, and capacitors, especially Lithium-ion capacitors.

The invention further pertains to a metal-ion secondary battery comprising the polymer membrane of the present invention as defined above as separator coating.

The metal-ion secondary battery is generally formed by assembling a negative electrode, the polymer membrane of the present invention as defined above and a positive electrode, plus the electrolyte solution fed in the battery.

The metal-ion secondary battery is preferably an alkaline or alkaline-earth secondary battery, more preferably a Lithium-ion secondary battery.

Non-limitative examples of suitable photo-electrochemical devices include, notably, dye-sensitized solar cells, photochromic devices and electrochromic devices.

Should the disclosure of any patents, patent applications, and publications which are incorporated herein by reference conflict with the description of the present application to the extent that it may render a term unclear, the present description shall take precedence.

The invention will be now described with reference to the following examples whose purpose is merely illustrative and not limitative of the present invention.

Raw Materials

Polymer FA: VDF/HEA (0.4% by moles)/HFP (2.5% by moles) copolymer having an intrinsic viscosity of 0.11 I/g in DMF at 25° C.

Tetraethylorthosilicate (TEOS) commercially available as liquid from Aldrich Chemistry purity >99%.

Ionic Liquid (IL): N-Propyl-N-methylpyrrolidinium bis(trifluoromethanesulfonyl)imide (Pyr13TFSI) of formula:

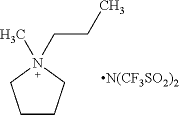

Citric acid: commercially available as crystals from Sigma Aldrich, purity 99%.

EC: ethylene carbonate

PC: propylene carbonate

Liquid Medium (L1): Pyr13TFSI.

Liquid Medium (L2): EC/PC 1:1 weight ratio.

Determination of Intrinsic Viscosity of Polymer (F) (DMF at 25° C.)

Intrinsic viscosity [η] (dl/g) was determined using the following equation on the basis of the dropping time, at 25° C., of a solution obtained by dissolving polymer (F) in dimethylformamide at a concentration of about 0.2 g/dl, in an Ubbelhode viscosimeter

$$[ η ] = \frac{{η}_{sp} + Γ \cdot ln {η}_{r}}{( 1 + Γ ) \cdot c}$$

where c is polymer concentration in g/dl;
ηr is the relative viscosity, i.e. the ratio between the dropping time of sample solution and the dropping time of solvent; ηₛₚ is the specific viscosity, i.e. η_{f}−1; Γ is an experimental factor, which for polymer (F) corresponds to 3.

Determination of Ionic Conductivity

The film of the invention obtained by extrusion (about 100-150 microns) was reduced to a thickness of 50 microns by compression moulding. Then, the membrane was dried in an oven for 3 h at 70° C. and it was put between two stainless steel electrodes in presence of a solution of 1M of LiPF₆ in L2 and sealed in a container. The resistance of the membrane was measured and the ionic conductivity (σ) was calculated using the following equation:

$$Ionic conductivity [ σ ] = \frac{d}{( {R}_{b} \times S )}$$

wherein d is the thickness of the film, R_{b} is the bulk resistance and S is the area of the stainless steel electrode.

Determination of SiO₂ Content in the Fluoropolymer Hybrid Organic/Inorganic Composite

The amount of SiO₂ in the fluoropolymer hybrid organic/inorganic composite was measured by Energy Dispersive Spectroscopy (EDS) analysis of Silicon (Si) and Fluorine (F) elements on micrographs obtained from Scanning Electron Microscopy (SEM). The SiO₂ content was determined by using the following equation (1):

SiO₂ [%]=[[SiO₂]/([SiO₂]+[F])]×100 (1)

wherein [SiO₂] and [F] from equation (1) are calculated using the following equations (2) and (3), respectively:

[SiO₂]=([Si_{EDS}]×60)/28 (2)

[F]=([F_{EDS}]×64)/38 (3)

wherein:
Si_{EDS} and F_{EDS} are the weight % of Si and F obtained by EDS,
60 is the molecular weight of SiO₂,
28 is the atomic weight of Si,
64 is the molecular weight of CH₂═CF₂, and
38 is the atomic weight of two F elements.

Preparation of Polymer FA

In a 80 liters reactor equipped with an impeller running at a speed of 250 rpm were introduced in sequence 50.2 kg of demineralised water and 3.80 g of METHOCEL® K100 GR and 15.21 g of Alkox® E45 as a couple of suspending agent. The reactor was purged with several sequences of vacuum (30 mmHg) and purged of nitrogen at 20° C. Then 187.3 g of a 75% by weight solution of t-amyl perpivalate initiator in isododecane. The speed of the stirring was increased at 300 rpm. Finally, 16.3 g of hydroxyethylacrylate (HEA) and 2555 g of hexafluoropropylene (HFP) monomers were introduced in the reactor, followed by 22.8 kg of vinylidene fluoride (VDF) were introduced in the reactor. The reactor was gradually heated until a set-point temperature at 55° C. and the pressure was fixed at 120 bar. The pressure was kept constantly equal to 120 bars by feeding 16.96 kg of aqueous solution containing a 188 g of HEA during the polymerization. After this feeding, no more aqueous solution was introduced and the pressure started to decrease. Then, the polymerization was stopped by degassing the reactor until reaching atmospheric pressure. A conversion around 81% of comonomers was obtained. The polymer so obtained was then recovered, washed with demineralised water and oven-dried at 65° C.

### Example 1: Preparation of Solid Composition (SCP) at Room Temperature at Different Amounts of TEOS Using Citric Acid as Catalyst and Carbonate Medium

Solid compositions (SCP) 1a, 1b, 1c and 1d were prepared starting from the liquid mixtures as reported in Table 1, in the presence of citric acid in a beaker of 50 or 500 ml capacity.

TABLE 1

| | 1a | 1b | 1c | 1d |
|---|---|---|---|---|
| | 50 ml | 50 ml | 50 ml | 500 ml |
| Liquid Medium (L2) (g) | 16.8 | 16.8 | 18 | 299.25 |
| TEOS (g) | 6.62 | 8.28 | 8.28 | 144.87 |
| H₂O (g) | 2.30 | 2.87 | 2.87 | 50.31 |
| EtOH (g) | 1.66 | 2.07 | 2.07 | 36.21 |
| Citric Ac. (g) | 0.089 | 0.11 | 0.11 | 1.95 |
| Polymer FA (g) | 5.28 | 4.8 | 3.6 | 183.75 |

Content of the solid compositions 1a, 1b, 1c and 1d:

1a: 70% liquid medium (L2): 8% SiO₂: 22% Polymer FA
1b: 70% liquid medium (L2): 10% SiO₂: 20% Polymer FA
1c: 75% liquid medium (L2): 10% SiO₂: 15% Polymer FA
1d: 57% liquid medium (L2): 8% SiO₂: 35% Polymer FA

Each liquid mixture thus obtained was allowed to react under magnetic stirring at 400 rpm. After 24 hours a solid composition (SCP) was obtained.

The results show that solid compositions (SCP) can be formed even at high content of liquid medium (L2).

### Example 2: Manufacture of the Polymer Membrane with Polymer FA

2a) Preparation of Solid Composition (SCP)

Example 1b was repeated in a 500 ml beaker equipped with a magnetic stirrer running at a speed in the range from 200 to 400 rpm increasing by 6 times the amount of each ingredient described in example 1b.

Then, it was put in the oven at 70° C. for 48 hours and then milled to obtain fine particles finer than 100 microns.

2b) Preparation of Polymer Membrane Comprising a Fluoropolymer Hybrid Organic/Inorganic Composite:

The solid composition prepared in example 2a was introduced using a gravimetric feeder into the feeding hopper of a twin screw co-rotating intermeshing extruder (Leistritz 18 ZSE 18 HP having a screw diameter D of 18 mm and a screw length of 720 mm (40 D)). The barrel was composed of eight temperature controlled zones and a cooled one that allows to set the desired temperature profile. In this case, the temperature profile was set in all zones at 90° C. The molten polymer went out from a die, composed of a flat profile of 1 mm thick and 40 mm length. The extrudate film was stretched between two cylinders of diameter 100 mm and width 100 mm with a gap from 100-500 um. The extrudated film was cooled in air and it has a thickness in between of 100 and 150 microns.

The RPM of the extruder was 235 rpm. The throughput was about 0.5 Kg/h.

The film has good mechanical properties: it can be manipulated without tearing the membrane.

The mechanical properties of the film thus obtained are shown in Table 2.

### Example 3: Manufacture of the Polymer Membrane with Polymer FA

A membrane was obtained as in Example 2 starting from the solid composition (SCP) obtained in Example 1d.

The mechanical properties of the film thus obtained are shown in Table 2.

The ionic conductivity of the film of about 50 microns was measured and the average value of three samples was 0.95 mS/cm.

TABLE 2

| | Young's | Stress at | Strain at |
|---|---|---|---|
| | modulus | break | break |
| Film | (Mpa) | (MPa) | (%) |
| Ex 2 (4 samples) | 14 ± 2 | 1.0 ± 0.2 | 120 ± 20 |
| Ex 3 (3 samples) | 33 ± 1 | 11 ± 1 | 77 ± 11 |

### Example 4 Preparation of Solid Composition (SCP) at Room Temperature Using Citric Acid as Catalyst and Ionic Liquid Medium

A solid composition (SCP) was prepared starting from the mixture as reported in Table 3, in a beaker of 50 ml capacity.

TABLE 3

| | |
|---|---|
| Liquid Medium (L1) (g) | 13.92 |
| TEOS (g) | 6.62 |
| EtOH (g) | 1.66 |
| H₂O (g) | 4.30 |
| Citric acid (g) | 0.089 |
| Polymer FA (g) | 8.16 |

The liquid mixture thus obtained was allowed to react under magnetic stirring at 400 rpm. After 20 hours a solid composition (SCP) was obtained.

The solid composition was extruded in a micro-extruder of 15 ml twin screw compounder (DSM Xplore) at 180° C. and at a speed of about 100 rpm. A film was obtained at 180° C. by compression moulding.

In view of the above, it has been found that the membrane of the invention advantageously exhibits outstanding ionic conductivity and good mechanical properties to be used as separator coating in standard Li-battery configurations.

1. A process for manufacturing a polymer membrane based on a fluoropolymer hybrid organic/inorganic composite, said process comprising the following steps:
(i) providing a mixture that comprises:
a metal compound of formula (I)
X₄₋ₘAYₘ (I)
wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)];
optionally, at least one acid catalyst; and
optionally, an aqueous liquid medium [medium (A)];
(ii) partially hydrolysing and/or polycondensing the metal compound of formula (I) by stirring the mixture provided in step (i) until the obtainment of a solid mixture (SM) that comprises a metal compound including one or more inorganic domains consisting of ≡A-O-A≡ bonds and one or more residual hydrolysable groups Y [metal compound (M)], wherein A and Y are as above defined;
and
(iii) mixing the solid mixture (SM) provided in step (ii) with at least one fluoropolymer [polymer (F)] comprising recurring units derived from at least one fluorinated monomer [monomer (FM)] and at least one monomer comprising at least one hydroxyl group [monomer (OH)], so as to provide a solid composition (SC);
and
(iv) processing the solid composition (SC) provided in step (iii) in the molten state, so that at least a fraction of hydroxyl groups of the monomer (OH) of polymer (F) reacts with at least a fraction of residual hydrolysable groups Y of said compound (M),
so as to obtain a polymer membrane comprising a fluoropolymer hybrid organic/inorganic composite including the liquid medium (L).

2. The process according to claim 3, wherein in step (ii) the mixture provided in step (i) is subjected to a vigorous stirring at a temperature of at least 30° C. for a time comprised in the range of from 24 to 48 hours.

3. The process according to claim 1, wherein step (ii) further comprises a step (ii_{bis}) of drying the solid mixture (SM) obtained in step (ii) at a temperature of at least 50° C.

4. The process according to claim 1, wherein step (ii) further includes a step (iiₜₑᵣ) of comminuting the solid mixture obtained in step (ii) or in step (ii_{bis}) so as to provide the solid mixture (SM) in the form of fine powder.

5. A process for manufacturing a polymer electrolyte based on a fluoropolymer hybrid organic/inorganic composite, said process comprising the following steps:
(a) providing a mixture that comprises:
a metal compound of formula (I)
X₄₋ₘAYₘ (I)
wherein m is an integer from 1 to 4, A is a metal selected from the group consisting of Si, Ti and Zr, Y is a hydrolysable group selected from the group consisting of an alkoxy group, an acyloxy group and a hydroxyl group, X is a hydrocarbon group, optionally comprising one or more functional groups,
a liquid medium [medium (L)];
optionally, at least one acid catalyst; and
optionally, an aqueous liquid medium [medium (A)]; and
at least one fluoropolymer [polymer (F)] comprising recurring units derived from at least one fluorinated monomer [monomer (FM)] and at least one monomer comprising at least one hydroxyl group [monomer (OH)];
and
(b) partially hydrolysing and/or polycondensing the metal compound of formula (I) by stirring the mixture provided in step (a) until the obtainment of a solid composition (SCP) that comprises a metal compound including one or more inorganic domains consisting of ≡A-O-A≡ bonds and one or more residual hydrolysable groups Y [metal compound (M)], wherein A and Y are as above defined and at least one polymer (F) as above defined;
and
(c) processing the solid composition (SCP) provided in step (b) in the molten state at least a fraction of hydroxyl groups of the monomer (OH) of polymer (F) reacts with at least a fraction of residual hydrolysable groups Y of said compound (M),
so as to obtain a polymer membrane comprising a fluoropolymer hybrid organic/inorganic composite including the liquid medium (L).

6. The process according to claim 5, wherein step (b) includes a further step (b_{bis}) of drying the composition obtained in step (b) at a temperature of at least 50° C.

7. The process according to claim 5, wherein step (b) further includes a step (bₜₑᵣ) of comminuting the solid mixture obtained in step (b) or in step (b_{bis}), so as to provide the solid mixture in the form of fine powder.

8. The process according to claim 1, wherein the metal compound of formula (I) is a non-functional compound selected from the group consisting of triethoxysilane, trimethoxysilane, tetramethyltitanate, tetraethyltitanate, tetra-n-propyltitanate, tetraisopropyltitanate, tetra-n-butyltitanate, tetra-isobutyl titanate, tetra-tert-butyl titanate, tetra-n-pentyltitanate, tetra-n-hexyltitanate, tetraisooctyltitanate, tetra-n-lauryl titanate, tetraethylzirconate, tetra-n-propylzirconate, tetraisopropylzirconate, tetra-n-butyl zirconate, tetra-sec-butyl zirconate, tetra-tert-butyl zirconate, tetra-n-pentyl zirconate, tetra-tert-pentyl zirconate, tetra-tert-hexyl zirconate, tetra-n-heptyl zirconate, tetra-n-octyl zirconate, tetra-n-stearyl zirconate.

9. The process according to claim 1, wherein the acid catalyst is an organic acid, preferably is citric acid or formic acid.

10. The process according to claim 1, wherein the medium (A) consists of water and ethanol.

11. The process according to claim 1, wherein the monomer (OH) is selected from the group consisting of (meth)acrylic monomers of formula (V) or vinylether monomers of formula (VI) 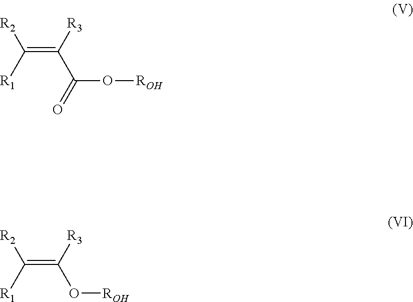
wherein each of R₁, R₂ and R₃, equal to or different from each other, is independently a hydrogen atom or a C₁-C₃ hydrocarbon group, and R_{OH} is a hydrogen atom or a C₁-C₅ hydrocarbon moiety comprising at least one hydroxyl group.

12. The process according to claim 1, wherein the polymer (F) comprises:
(a) at least 60% by moles of vinylidene fluoride (VDF);
(b) optionally, from 0.1% to 15% by moles of a fluorinated comonomer selected from chlorotrifluoroethylene (CTFE), hexafluoropropene (HFP), tetrafluoroethylene (TFE), trifluoroethylene (TrFE), perfluoromethylvinylether (PMVE) and mixtures therefrom; and
(c) from 0.050% to 10% by moles of monomer (OH) of formula (V) 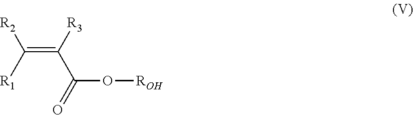
wherein each of R₁, R₂, R₃, equal to or different from each other, is independently a hydrogen atom or a C₁-C₃ hydrocarbon group and R_{OH} is a C₁-C₅ hydrocarbon moiety comprising at least one hydroxyl group.

13. A solid composition (SC) obtained according to step (iii) of the process of claim 1.

14. A solid composition (SCP) obtained according to step (b) of the process of claim 5.

15. A polymer membrane obtained by the processes according to claim 1.

16. The process of claim 12, wherein polymer (F) comprises:
(a) at least 85% by moles of vinylidene fluoride (VDF);
(b) optionally, from 0.1% to 10% by moles of a fluorinated comonomer selected from chlorotrifluoroethylene (CTFE), hexafluoropropene (HFP), tetrafluoroethylene (TFE), trifluoroethylene (TrFE), perfluoromethylvinylether (PMVE) and mixtures therefrom; and
(c) from 0.2 to 3.0% by moles of monomer (OH) of formula (V).
